(19) United States
(12) Patent Application Publication
(10) Pub. No.: US 2010/0131077 A1
(43) Pub. Date: May 27, 2010

(54) Data Collection Systems and Methods for Motion Control

(76) Inventor: David W. Brown, Bingen, WA (US)

Correspondence Address: SCHACHT LAW OFFICE , INC., ROY-G-BIV CORPORATION, SUITE 202, 2801 MERIDIAN ST., BELLINGHAM, WA, 98225, US

(21) Appl. No.: 12/271,724

(22) Filed: Nov. 14, 2008

Related U.S. Application Data
(63) Continuation of application No. 11/067,327, filed on Feb. 25, 2005, now abandoned.
(60) Provisional application No. 60/547,650, filed on Feb. 25, 2004.

(51) Int. Cl. G05B 11/01

(52) U.S. Cl. 700/11

(57) ABSTRACT

A motion control system comprising a data processing system, a controller for controlling a motion machine, and a motion driver. The data processing system stores a trigger variable, a dependant action associated with the trigger variable, and a set of predetermined trigger conditions. The controller stores data values indicative of a state of the motion machine. Data values stored by the controller are associated with the trigger variable. The motion driver reads data values from and writes data values to the controller. The data processing system directs the motion driver to read from the controller, at a plurality of points in time, a trigger data value associated with the trigger variable. When the trigger data value associated with the trigger variable meets the predetermined trigger conditions, the data processing system directs the motion driver to take the dependant action.

### RELATED APPLICATIONS

This application (Attorneys' Ref. No. P216068) is a continuation of U.S. patent application Ser. No. 11/067,327 filed Feb. 25, 2005, which claims priority of U.S. Provisional Patent Application Ser. No. 60/547,650, filed Feb. 25, 2004. The contents of all related application listed above are incorporated herein by reference.

### TECHNICAL FIELD

The present invention relates to motion control systems and, in particular, to the acquisition and processing of data associated with motion control systems.

### BACKGROUND OF THE INVENTION

The purpose of a motion control machine or device is to move an object in a desired manner. The basic components of a motion control machine or device are a controller and a mechanical system. The mechanical system translates signals generated by the controller into movement of an object.

While the mechanical system commonly comprises a drive and an electrical motor, a number of other systems, such as hydraulic or vibrational systems, can be used to cause movement of an object based on a control signal. Additionally, it is possible for a motion control machine or device to comprise a plurality of drives and motors to allow multi-axis control of the movement of the object.

The present invention is of particular importance in the context of a mechanical system including at least one drive and electrical motor having a rotating shaft connected in some way to the object to be moved, and that application will be described in detail herein. The principles of the present invention are, however, generally applicable to any mechanical system that generates movement based on a control signal. The scope of the present invention should thus be determined based on the claims appended hereto and not the following detailed description.

In a motion control machine or device comprising a controller, a drive, and an electrical motor, the motor is physically connected to the object to be moved such that rotation of the motor shaft is translated into movement of the object. The drive is an electronic power amplifier adapted to provide power to a motor to rotate the motor shaft in a controlled manner. Based on control commands, the controller controls the drive such that the object is moved in the desired manner.

These basic components are typically placed into a larger motion control system to accomplish a specific task. For example, one controller may operate in conjunction with several drives and motors in a multi-axis system for moving a tool along a predetermined path relative to a workpiece.

The term “machine” is typically used in the industry to refer to a physical machine or asset used to perform a specified task. A machine may be any self-powered machine or device, mobile or stationary, that is either directly controlled by humans or automatically controlled using computers. As examples, a machine may be a CNC Mill used to shape metal, a pick-n-place machine used to position parts on a circuit board, a robotic machine used to perform surgery, a medical data input device used to collect vital information from a human (e.g., blood glucose meter, asthma meter, etc.), a gaming device used when playing a game, a robotic toy, an animatronics figure, a robotic machine used to deliver goods to a warehouse or to people, an land vehicle such as an automobile, truck, or farm vehicle, a watercraft such as a boat or ship, an aircraft such as an airplane, jet, helicopter, or spaceship. The term “device” is generally used to refer to a machine and often to a machine with a smaller footprint.

Additionally, the basic components described above are often used in conjunction with a host computer or programmable logic controller (PLC). The host computer or PLC allows the use of a high-level programming language to generate control commands that are passed to the controller. Software running on the host computer is thus designed to simplify the task of programming the controller.

Companies that manufacture motion control devices are, traditionally, hardware oriented companies that manufacture software dedicated to the hardware that they manufacture. These software products may be referred to as low level programs. Low level programs usually work directly with the motion control command language specific to a given motion control device. While such low level programs offer the programmer substantially complete control over the hardware, these programs are highly hardware dependant.

In contrast to low-level programs, high-level software programs, sometimes referred to as factory automation applications, allow a factory system designer to develop application programs that combine large numbers of input/output (I/O) devices, including motion control devices, into a complex system used to automate a factory floor environment. These factory automation applications allow any number of I/O devices to be used in a given system, as long as these devices are supported by the high-level program. However, custom applications, developed by other software developers, cannot be developed to take advantage of the simple motion control functionality offered by the factory automation program. Additionally, these programs do not allow the programmer a great degree of control over the each motion control device in the system. Each program developed with a factory automation application must run within the context of that application.

Motion control machines or devices contain, generate, and/or otherwise use data in a variety of forms. In the context of the present application, the terms “data” and “data items” are used to refer to any numeric or string data associated with a target motion control machine or device (the target machine) in an analog or digital format that is compatible with computer systems. For example, BIT, BYTE, WORD, DWORD, LONG, REAL, DOUBLE, FLOAT, STRING, ASCII STRING are a few data types that represent data items. Data items may server a variety of purposes and may take the form of values stored by the target machine, commands to be performed by the target machine, and/or responses sent from the target machine. A data target is any location on a motion device or machine that can produce data or data items.

Data may be collected from data sources or targets by reading register values on the data source, reading shared memory provided by the data source, sending commands to the data source for which a data response is given containing the data requested, reading variables provided by the data source, reading and writing to variables in a sequence necessary to produce data values, querying data using a proprietary or standard data protocol, calling a function provided by the target data source, etc.

A value is typically associated with each data item. The value associated with a data item may be a number, word, or the like, and the value associated with a particular data item may change as the state of the target machine changes. In large motion control systems, data residing on the motion control machine is collected for a variety of reasons, such as determining whether the motion control system is operating properly.

Motion control systems are commonly “event driven” systems in which data items are served to a data client based on the occurrence of a predetermined software event. In an event driven system, a data client typically “polls” the data source to obtain the latest value for the data item. Data “polling” is the process of continually reading a data item to ensure that the client always has the most recent value associated with a particular data item. The term “continually” as used herein with respect to the reading of data refers to reading data at a plurality of discrete points in time. Data may be read synchronously or asynchronously. The reading data items uses processor time and, in some situations, network bandwidth.

The need thus exists for motion control systems that optimize the collection of data items to minimize the use of processor time and network bandwidth.

### RELATED ART

A number of software programs currently exist for programming individual motion control devices or for aiding in the development of systems containing a number of motion control devices.

The following is a list of documents disclosing presently commercially available high-level software programs: (a) Software Products For Industrial Automation, Iconics 1993; (b) The complete, computer-based automation tool (IGSS), Seven Technologies A/S; (c) OpenBatch Product Brief, PID, Inc.; (d) FIX Product Brochure, Intellution (1994); (e) Paragon TNT Product Brochure, Intec Controls Corp.; (f) WEB 3.0 Product Brochure, Trihedral Engineering Ltd. (1994); and (g) AIMAX-WIN Product Brochure, TA Engineering Co., Inc. The following documents disclose simulation software: (a) ExperTune PID Tuning Software, Gerry Engineering Software; and (b) XANALOG Model NL-SIM Product Brochure, XANALOG.

The following list identifies documents related to low-level programs: (a) Compumotor Digiplan 1993-94 catalog, pages 10-11; (b) Aerotech Motion Control Product Guide, pages 233-34; (c) PMAC Product Catalog, page 43; (d) PC/DSP-Series Motion Controller C Programming Guide, pages 1-3; (e) Oregon Micro Systems Product Guide, page 17; (f) Precision Microcontrol Product Guide.

The Applicants are also aware of a software model referred to as WOSA that has been defined by Microsoft for use in the Windows programming environment. The WOSA model is discussed in the book Inside Windows 95, on pages 348-351. WOSA is also discussed in the paper entitled WOSA Backgrounder: Delivering Enterprise Services to the Windows-based Desktop. The WOSA model isolates application programmers from the complexities of programming to different service providers by providing an API layer that is independent of an underlying hardware or service and an SPI layer that is hardware independent but service dependant. The WOSA model has no relation to motion control devices.

The Applicants are also aware of the common programming practice in which drivers are provided for hardware such as printers or the like; an application program such as a word processor allows a user to select a driver associated with a given printer to allow the application program to print on that given printer.

While this approach does isolate the application programmer from the complexities of programming to each hardware configuration in existence, this approach does not provide the application programmer with the ability to control the hardware in base incremental steps. In the printer example, an application programmer will not be able to control each stepper motor in the printer using the provided printer driver; instead, the printer driver will control a number of stepper motors in the printer in a predetermined sequence as necessary to implement a group of high level commands.

The software driver model currently used for printers and the like is thus not applicable to the development of a sequence of control commands for motion control devices.

The Applicants are additionally aware of application programming interface security schemes that are used in general programming to limit access by high-level programmers to certain programming variables. For example, Microsoft Corporation's Win32 programming environment implements such a security scheme. To the Applicants' knowledge, however, no such security scheme has ever been employed in programming systems designed to generate software for use in motion control systems.

### SUMMARY OF THE INVENTION

The present invention may be embodied as a motion control system comprising a data processing system, a controller for controlling a motion machine, and a motion driver. The data processing system stores a trigger variable, a dependant action associated with the trigger variable, and a set of predetermined trigger conditions. The controller stores data values indicative of a state of the motion machine. Data values stored by the controller are associated with the trigger variable. The motion driver reads data values from and writes data values to the controller. The data processing system directs the motion driver to read from the controller, at a plurality of points in time, a trigger data value associated with the trigger variable. When the trigger data value associated with the trigger variable meets the predetermined trigger conditions, the data processing system directs the motion driver to take the dependant action.

### BRIEF DESCRIPTION OF THE DRAWINGS

FIG. 1 is a module interaction map illustrating interactions between modules forming an event trigger system of the present invention and a machine forming part of a motion control system;

FIG. 2 is an object interaction map illustrating the interaction of various objects forming one example of the event trigger system of FIG. 1;

FIG. 3 is a case diagram illustrating a Subscribing To Data Use Case of the example of the event trigger system of FIG. 2;

FIG. 4 is a case diagram illustrating a Registering an Event Trigger Use Case of the example of the event trigger system of FIG. 2;

FIG. 5 is a case diagram illustrating a Normal Event Firing Use Case of the example of the event trigger system of FIG. 2;

FIG. 6 is a case diagram illustrating a Event Trigger Event Firing Use Case of the example of the event trigger system of FIG. 2;

FIG. 7 is an object interaction map illustrating the interaction of various objects forming a second example of the event trigger system of FIG. 1;

FIG. 8 is a case diagram illustrating a Event Trigger Event Firing Use Case of the example of the event trigger system of FIG. 7; and

FIG. 9 schematically depicts the component interfaces exposed by the motion server module of the present invention.

### DETAILED DESCRIPTION OF THE INVENTION

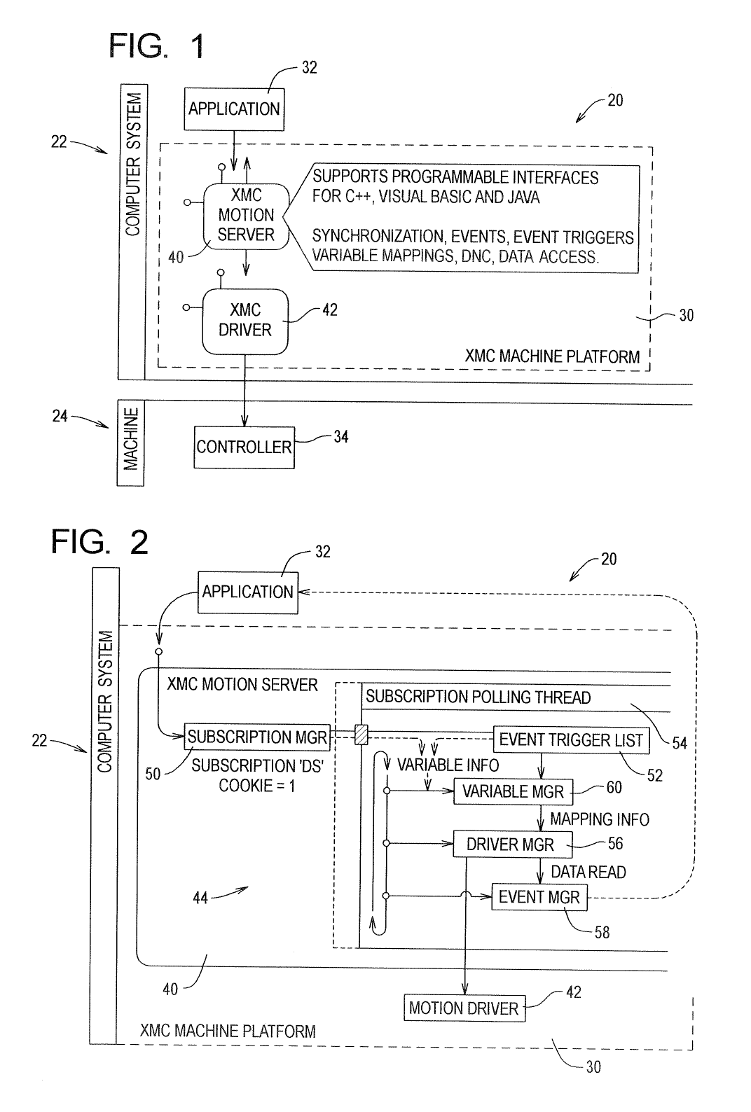

Referring initially to FIG. 1 of the drawing, depicted therein is a motion control system 20 constructed in accordance with, and embodying, the principles of the present invention. The example motion control system 20 comprises a computer system 22 and a motion device or machine 24. The example computer system 22 comprises a motion machine platform 30 and an application program 32. The motion device 24 comprises a controller 34 through which the motion device 24 is controlled.

The controller 34 is typically hardware and/or software that contains the logic used to run the motion device or machine 24. Typically, the controller is a PLC, CNC, or Motion controller. The controller contains the main control loop used to position, monitor, and/or otherwise direct the machine to carry out useful tasks and typically automated tasks.

The application program 32 defines a sequence of steps corresponding to a desired task to be accomplished by the motion device or machine 24. The example application program 32, which may be referred to as the data client or client software, may reside on same computer system 22 as the motion server 40. The application program 32 is typically an executable, but may also be a DLL, Component, or other Module.

The example application program 32 may also reside on a remote computer system connected to the computer system 22 using a local or wide area communications network. The term “network” as used herein refers to any link between two or more computer systems. A network may take the form of a packet based network, a streaming based network, broadcast based network, or a peer-to-peer based network. Several network examples include a TCP/IP network, the Internet, an Intranet, a wireless network using WiFi, a wireless network using radio waves and/or other light based signals.

The motion machine platform 30 comprises modules such as a motion server 40 and a motion driver 42. The term “module” is used herein to refer to a binary block of computer logic that contains functions, objects, components, ActiveX components, .NET source, HTML, XML and/or other computer code that can be executed in real-time or in script form. Several examples of a module include an executable EXE, a dynamic link library DLL, an OLE component or set of components housed within a DLL or EXE, an ActiveX Control, an HTML or XML based Control, a VB script source file, a Java Serverlet, Java Control, Java Object, .NET Package.

The motion server 40 defines an application programming interface through which the application program 32 communicates with the motion driver 42. As shown in FIG. 2, the motion server 40 further comprises a data processing system 44 that collects and or processes data from the controller 34 as will be described in further detail below.

The motion server 40 may further optionally comprise or incorporate a control command generating system for generating hardware specific control commands for the motion machine 24 based on generic application commands forming the application program 32. An example of a hardware independent motion control system that may be used as part of the motion server 40 is described, for example, in U.S. Pat. No. 5,691,897 to Brown.

The motion driver 42 implements the specific hardware logic necessary to read data from and write data to the controller 34. The data processing system 44 may also be used to command the controller 34 to transfer data to the target machine 24 that causes the target machine 24 carry out actions and/or to configure the controller 34.

The example data processing system 44 comprises a subscription manager 50, an event trigger list 52, a subscription polling thread 54, a driver manager 56, and an event manager 58. Optionally, the data processing system 44 may further comprise a variable manager 60.

The subscription manager 50 is responsible for managing the event trigger list 52. The event trigger list 52 stores a list of data item subscriptions, which will be referred to herein as trigger variables. Generally speaking, the term “variable” as used herein refers to a data item that has a name and, optionally, associated data. A data item may be a function call, a named data variable, a tag within a database, or the like. The name variable and data item are used herein interchangeably for a data point that includes one or more atomic data elements.

The subscription manager 50 further stores in the event trigger list predetermined trigger conditions associated with each trigger variable. The event trigger list 52 further stores one or more dependant actions associated with trigger variables. The dependant actions may be, for example, the reading of data items registered as dependant variables or causing the controller 34 to perform a particular action. When the data processing system 44 determines that the predetermined trigger conditions associated with a given trigger variable are met, the dependant actions associated with that given trigger variable are carried out.

The subscription manager 50 uses the subscription polling thread 52 to poll for changes in the trigger variables. The driver manager 56 is responsible for reading values associated with the trigger variables from the target motion device 24. The driver manager 56 is also used to read all dependant variables and/or to instruct the controller 34 to carry out any dependant actions associated as determined by the application program 32. The event manager 58 is used to fire events to any clients, such as the application program 32, that have registered or subscribed trigger variables with the subscription manager 50.

In general, the data processing system 44 allows a single trigger variable to be polled on the target system 24 and, upon detecting that a value associated with the trigger variable meets the predetermined trigger conditions, takes one or more dependant actions. Typically, but not necessarily, a relationship exists between the trigger variables and the dependant action or actions associated therewith. Because of this relationship, a change in the trigger variable suggests that the application program 32 should take some predetermined action such as updating the values associated with the dependant variables.

The dependant actions that may be taken when the value associated with the trigger variable meets the predetermined trigger conditions thus include, but are not limited to: (a) reading from the controller 34 data items associated with dependant variables; (b) generating events to be processed by the application program 32, such as sending to the application program 32 data items relating to dependant variables or groups of dependant variables; (c) writing one or more data items to the controller 34; and/or (d) writing to the controller 34 data items that direct the machine 24 to move to a predefined location.

Examples of predetermined trigger conditions include a change in a value associated with a trigger variable and/or the value associated with the trigger variable equaling a predefined value or falling within a predetermined range.

The trigger variables, the dependant actions, and the predetermined trigger conditions are all selected based on knowledge of the motion device 24. Appropriate selection of predetermined trigger conditions allows the transfer and processing of data between a data client such as the application program 32 and a data target such as the motion device 24 to be optimized. The motion device 24 thus allows the system 20 to transfer data between the data target and the data client only when necessary, thereby using more effectively the bandwidth on both the local processor and the communication line (e.g., network) to the target machine.

One common use of the example motion control system 20 is to use a trigger variable to optimize how data is read from the controller 34. For example, the application program 32 may register with the data processing system 44 a trigger variable called ‘DATAREADY’. When a change from “0” to “1” in a value that is associated with the DATAREADY variable is detected, the data processing system 44 reads from the controller 34 all dependant variables that have been registered as being associated with the DATAREADY trigger variable.

Further, the dependant action may further include the data processing system 44 sending to the client application program 32, in the form of an event, the dependant variables read from the controller 34. The exact form of the event generated by the data processing system 44 is not critical. Examples of event protocols that may be used include the events supported by COM/OLE called connection points and the loosely coupled events supported by COM+.

In this example, the dependant action performed by the data processing system 44 may further comprise the step of writing to the target machine 24 a data item that changes the DATAREADY trigger variable back to “0”, thereby indicating that all data associated with the dependant variables has been read. When the conditions are appropriate, the target machine 24 may subsequently change the value of the DATAREADY trigger variable from “0” back to “1”. Accordingly, when the DATAREADY trigger variable is next polled, the data processing system 44 will repeat the dependant action as just described.

With the foregoing basic understanding of the motion control system 20 of the present invention, the details of the construction and operation of this system 20 will now be described in further detail.

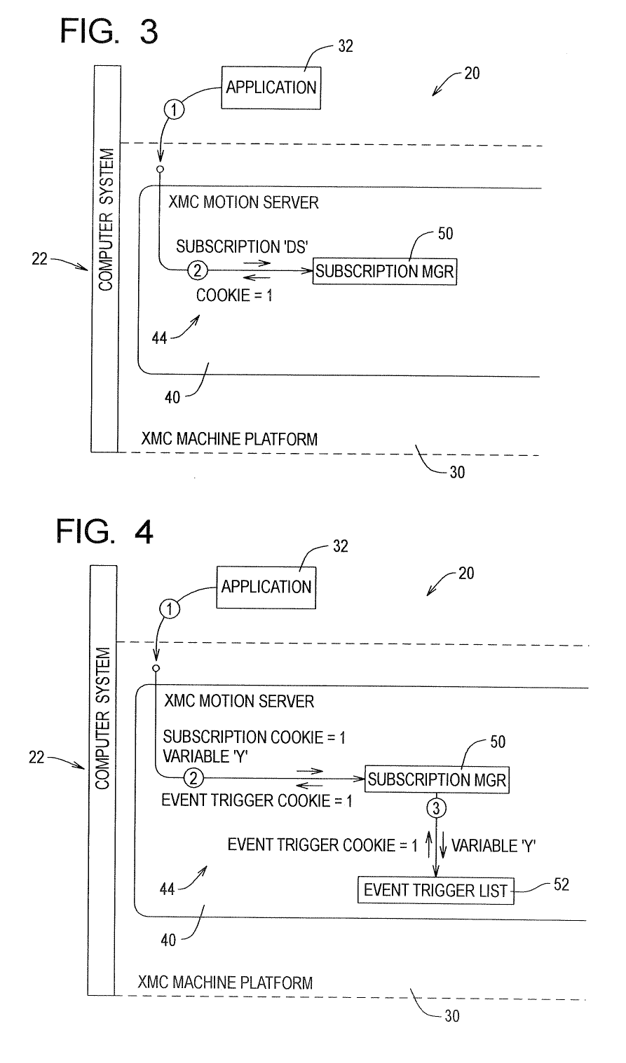

Referring now to FIG. 3 of the drawing, depicted therein are the steps that are performed when the client application 32 registers or subscribes a trigger variable with the subscription manager 50. In particular, the trigger variable must first be subscribed with motion server 42 by the client application 32 before any trigger variables can cause any associated dependant events or actions to occur. The process of subscribing with the subscription manager 50 notifies the data processing system 44 that the client application 32 requires a dependant action when the trigger variable meets a set of predetermined trigger conditions defined by the subscription.

In a first step, the application 32 calls the data processing system 44 and directs the data processing system 44 to subscribe or identify a given variable or data item as a trigger variable. At a second step, the data processing system 44 directs the subscription manager 50 to subscribe to the given variable or data item. The subscription manager 50 returns a cookie which represents a value unique to the subscription. At this point, the data processing system 44 is ready to have dependant actions and/or dependant data items or variables registered in association with the trigger variable subscription.

Referring now to FIG. 4 of the drawing, depicted therein are the steps that are performed after the client application 32 has registered or subscribed a variable as a trigger variable. In particular, after a variable has been registered or subscribed as a trigger variable, another data item, variable, or action must be associated with the variable or data item that has been identified by the client as a trigger variable.

In a first step, the client application 32 directs the data processing system 44 to register as a dependant action a variable or data item to be read and/or other action to occur. The client application 32 further directs the data processing system 44 to store the trigger conditions associated with the subscribed trigger variable. For example, the trigger conditions may define a value of or changes in the trigger variable that fire a trigger event that causes the data processing system 44 to take the dependant action.

In a second step, the data processing system 44 internally routes the request to register the dependant action and trigger conditions to the subscription manager 50. In a third step, the subscription manager 50 adds the dependant action to the event trigger list such that the dependant action is associated with the trigger variable. At this point the data processing system 44 is ready to take the dependant action, such as servicing the dependant variables and/or data items and/or taking other action, associated with the trigger variable.

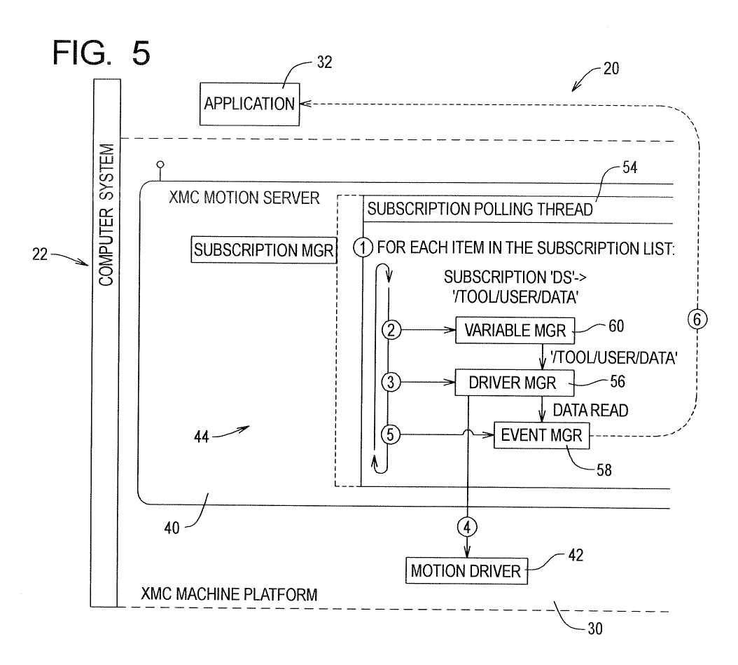

Referring now to FIG. 5 of the drawing, depicted therein are the steps that occur when the predetermined trigger conditions are met. The case depicted in FIG. 5 illustrates the simple case in which the dependant action in which the motion server 42 fires a trigger event.

First, within the subscription polling thread 54, each trigger variable or data item managed by the subscription manager 50 is processed to see whether the predetermined trigger conditions are satisfied and an event should fire for any given trigger variable or data item. To process each individual trigger variable, the following steps occur.

In an optional second step, the variable manager 60 is optionally used to convert target agnostic variable information (i.e. a generic variable name) into target specific variable information. In particular, the motion control system 20 may be hardware dependant, in which case the application program 32 will use target specific variable information and the variable manager 60 is not required.

However, if the motion control system 20 is hardware independent, the application program 32 may identify trigger variables and dependant actions and variables using generic or agnostic variable names. In this case, the variable manager 60 converts the agnostic variable names into target specific variable names.

In a third step, the driver manager 56 is directed to read the trigger variable or variables. Each trigger variable may be polled at the same rate, or certain trigger variables may be polled more frequently than other trigger variables. In any case, the trigger variables may be polled synchronously or in response to an asynchronous event.

In a fourth step, the driver manager 56 uses the associated motion driver 42 to interact with the controller 32 of the target machine 24 to obtain the data associated with the trigger variable or data item.

In a fifth step, upon receiving the trigger variable data, the trigger variable is compared against the predetermined trigger conditions. If the predetermined trigger condition is met, the event manager 58 takes the dependant action, which in the example of FIG. 5 is to fire the trigger event to the client application 32 at a sixth step.

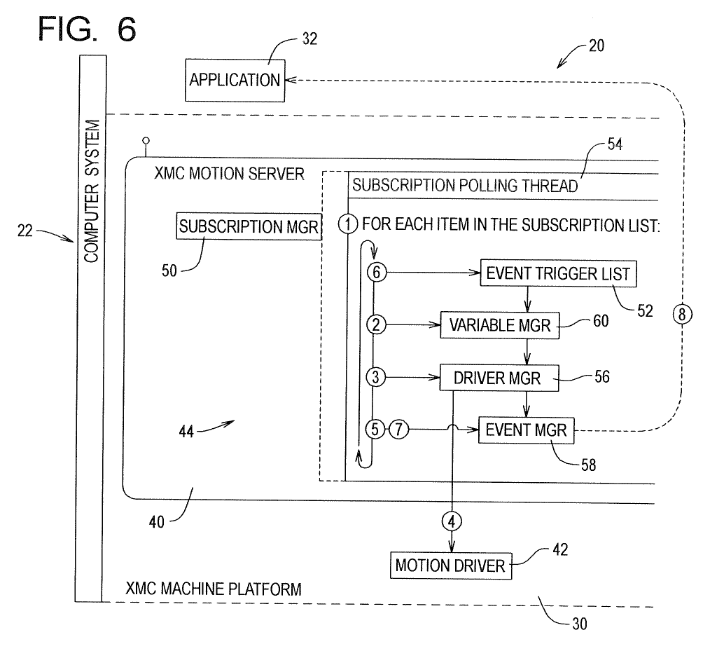

With the foregoing understanding of the simple event trigger case depicted in FIG. 5, the steps that take place when the dependant action requires actions in addition to the firing of a trigger event will be described with reference to FIG. 6. In particular, in addition to firing a trigger event, a dependant action may dictate that the data processing system 44 take other associated actions such as data reads and/or writes.

In a first step, within the subscription polling thread 54, each trigger variable or data item managed by the subscription manager 50 is polled and processed to determine whether the trigger conditions are met and the dependent action should be taken. To process each trigger variable, the following steps occur.

In a second step, the variable manager 60 is optionally used to convert target generic or agnostic variable information into target specific variable information. In a third step, the driver manager 56 is directed to read the trigger variable or variables.

In a fourth step, the driver manager 56 uses the associated motion driver 42 to interact with the target machine 24 and read the data associated with the trigger variable or data item.

In a fifth step, the data processing system 44 compares values associated with the trigger variable or data item against the trigger conditions to determine whether the trigger conditions are met.

If the predetermined trigger condition is met, the event trigger list 52 is queried at a sixth step for all associated dependant actions, including dependent variables that are to be read or written and/or actions that are to be carried out. If an associated dependant variable is to be read then the second and fourth steps are carried out on the dependant variable. If an action is to occur, the action occurs at this point or is queued for action in the near future.

In a seventh step, after the data processing system 44 receives the data containing the values associated with the dependant variable or variables, the event manager 58 is used to fire an event containing the dependant variable data to the client application 32. Optionally, to optimize bandwidth usage, the data representing values of all dependant variables associated with the trigger variable may be collected and sent to the client application 32 in a single event. In an eighth step, the event manager 58 fires the trigger event to the client application 32.

At this point, the event trigger variable has been satisfied for one condition. The polling loop continues and, should the predetermined trigger condition be satisfied for the trigger variable again, the sequence of steps described above repeats.

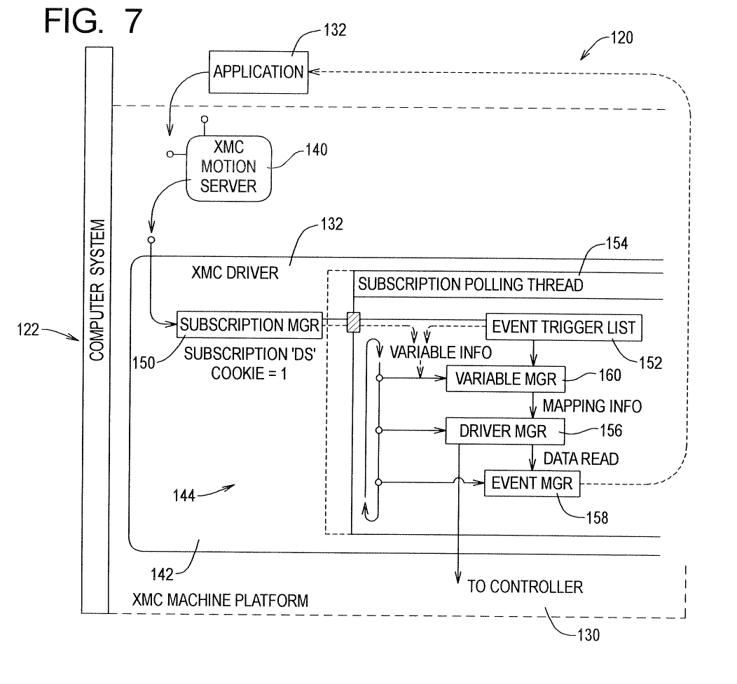

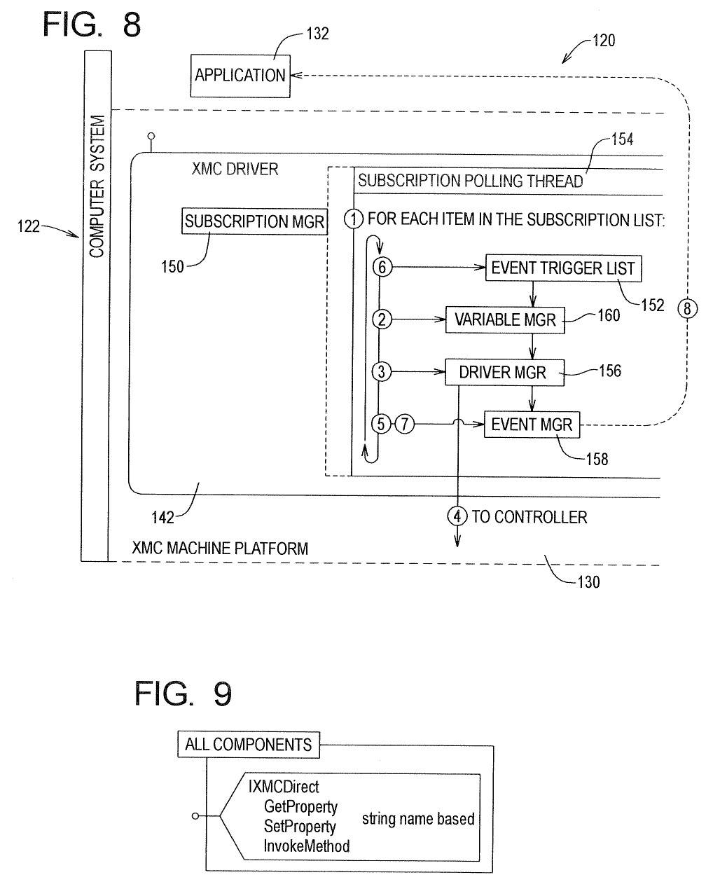

Referring now to FIGS. 7 and 8, depicted therein is another example motion control system 120 of the present invention. Except as will be described below, the motion control system 120 is similar in construction and operation to the example motion control system 20 described above.

Like the example motion control system 20 described above, the motion control system 120 comprises a computer system 122 and a motion device or machine (not shown). The example computer system 122 comprises a motion machine platform 130 and an application program 132. As with the system 20 described above, the motion device comprises a controller (not shown) through which the motion device is controlled.

The application program 132 defines a sequence of steps corresponding to a desired task to be accomplished by the motion device or machine. The example application program 132, which may be referred to herein as the data client, may reside on same computer system 122 as the motion server 140 or on a remote computer system connected to the computer system 122 using a local or wide area communications network.

The motion machine platform 130 comprises a motion server 140 and a motion driver 142. The motion server 140 defines an application programming interface through which the application program 132 communicates with the motion driver 142. The motion server 140 may further optionally comprise or incorporate a control command generating system for generating hardware specific control commands for the motion machine 24 based on generic application commands forming the application program 132. An example of a hardware independent motion control system that may be used as part of the motion server 140 is described, for example, in U.S. Pat. No. 5,691,897 to Brown.

The motion driver 142 implements the specific hardware logic necessary to read data from and write data to the controller. As shown in FIGS. 7 and 8, the motion driver 142 further comprises a data processing system 144 that collects and or processes data from the controller in substantially the same manner as the data processing system 44 described above. The data processing system 144 may also be used to command the controller to transfer data to the target machine that causes the target machine carry out actions and/or to configure the controller.

The example data processing system 144 comprises a subscription manager 150, an event trigger list 152, a subscription polling thread 154, a driver manager 156, and an event manager 158. Optionally, the data processing system 144 may further comprise a variable manager 160.

The subscription manager 150 is responsible for managing the event trigger list 152. The event trigger list 152 stores a list of data item subscriptions, which will be referred to herein as trigger variables. The subscription manager 150 further stores in the event trigger list predetermined trigger conditions associated with each trigger variable. The event trigger list 152 further stores one or more dependant actions associated with trigger variables. The dependant actions may be, for example, the reading of data items registered as dependant variables or causing the controller to perform a particular action. When the data processing system 144 determines that the predetermined trigger conditions associated with a given trigger variable are met, the dependant actions associated with that given trigger variable are carried out.

The subscription manager 150 uses the subscription polling thread 152 to poll for changes in the trigger variables. The driver manager 156 is responsible for reading values associated with the trigger variables from the target motion device. The driver manager 156 is also used to read all dependant variables and/or to instruct the controller to carry out any dependant actions associated as determined by the application program 132. The event manager 158 is used to fire events to any clients, such as the application program 132, that have registered or subscribed trigger variables with the subscription manager 150.

The use cases implemented by the data processing system 144 are similar to those described above with reference to the data processing system 44. Only the Event Trigger Firing From Driver use case of the data processing system 144 will be described herein, with reference to FIG. 8.

In a first step, within the subscription polling thread 154, each trigger variable or data item managed by the subscription manager 150 is polled and processed to determine whether the trigger conditions are met and the dependant action should be taken. To process each trigger variable, the following steps occur.

In a second step, the variable manager 160 is optionally used to convert target generic or agnostic variable information into target specific variable information. In a third step, the driver manager 156 is directed to read the trigger variable or variables.

In a fourth step, the driver manager 156 uses the motion driver 142 to interact with the target machine and read the data associated with the trigger variable or data item.

In a fifth step, the data processing system 144 compares values associated with the trigger variable or data item against the trigger conditions to determine whether the trigger conditions are met.

If the predetermined trigger condition is met, the event trigger list 152 is queried at a sixth step for all associated dependant actions, including dependent variables that are to be read or written and/or actions that are to be carried out. If an associated dependant variable is to be read then the second and fourth steps are carried out on the dependant variable. If an action is to occur, the action occurs at this point or is queued for action in the near future.

In a seventh step, after the data processing system 144 receives the data containing the values associated with the dependant variable or variables, the event manager 158 is used to fire an event containing the dependant variable data to the client application 132. Optionally, to optimize bandwidth usage, the data representing values of all dependant variables associated with the trigger variable may be collected and sent to the client application 132 in a single event. In an eighth step, the event manager 158 fires the trigger event to the client application 132.

At this point, the event trigger variable has been satisfied for one condition. The polling loop continues and, should the predetermined trigger condition be satisfied for the trigger variable again, the sequence of steps described above repeats.

Referring now to FIG. 9 of the drawing, the interfaces forming the components used in the motion control systems 20 and 120 will now be described in further detail. The motion servers 40 and 140 and the data processing systems 44 and 144 are highly modular systems comprising a set of components. A component is a logical organization of computer logic designed to perform a set of operations. Several examples of components are OLE Components, ActiveX Controls, HTML or XML based Controls, an HTML or XML based object, a .NET object, a Visual Basic based object, or the like. The example components described herein employ component technology created by Microsoft Corporation and identified as OLE/COM technology.

FIG. 9 illustrates that the motion server 40 implements an interface, referred to as the IXMCDirect interface, which is used to program the motion server 40. A similar interface is used to program the motion server 140 and the data processing system 144 of the motion control system 120.

The IXMCDirect Interface is used for communications with the motion server 40. The following methods make up the IXMCDirect interface, as specified in standard OLE/COM IDL format.

The IXMCDirect Interface comprises the following functions: GetProperty, SetProperty, and InvokeMethod. The GetProperty method is used to query a specific property from the component implementing the interface. The SetProperty method is used to set a specific property from the component implementing the interface. The InvokeMethod method is used to invoke a specific action on the component implementing the interface. It should be noted that an action can cause an event to occur, carry out a certain operation, query a value and/or set a value within the component implementing the method. A more detailed description of each method implemented by the object is described below.

### IXMCDirect::GetProperty Method

The IXMCDirect::GetProperty method is used to query the property corresponding to the property name ‘pszPropName’. Each component defines the properties that it supports.

| | |
|---|---|
| Syntax | HRESULT GetProperty( LPCTSTR pszPropName, |
| | LPXMC_PARAM_DATA rgData, |
| | DWORD dwCount ); |
| Pa- | LPCTSTR pszPropName - string name of the property to |
| rameters | query. |
| | LPXMC_PARAM_DATA rgData - array of |
| | XMC_PARAM_DATA types that specify each parameter |
| | corresponding to the property. For example, a certain |
| | property may be made up of a number of elements - in this |
| | case an array of XMC_PARAM_DATA items is returned, |
| | one for each element making up the property. In most |
| | cases a property is made up of a single element, thus a |
| | single element array is passed to this method. For more |
| | information on the XMC_PARAM_DATA type, see below. |
| | DWORD dwCount - number of XMC_PARAM_DATA |
| | elements in the rgData array. |
| Return | HRESULT - NOERROR on success, or error code on |
| Value | failure. |

### IXMCDirect::SetProperty Method

The IXMCDirect::SetProperty method is used to set a property in the component corresponding to the ‘pszPropName’ property. For the set of properties supported by the component, see the specific component description.

| | |
|---|---|
| Syntax | HRESULT SetProperty( LPCTSTR pszPropName, |
| | LPXMC_PARAM_DATA rgData, |
| | DWORD dwCount ); |
| Pa- | LPCTSTR pszPropName - string name of the property to |
| rameters | set. |
| | LPXMC_PARAM_DATA rgData - array of |
| | XMC_PARAM_DATA types that specify each parameter |
| | corresponding to the property. For example, a certain |
| | property may be made up of a number of elements - in this |
| | case an array of XMC_PARAM_DATA items is returned, |
| | one for each element making up the property. In most |
| | cases a property is made up of a single element, thus a |
| | single element array is passed to this method. For more |
| | information on the XMC_PARAM_DATA type, see below. |
| | DWORD dwCount - number of XMC_PARAM_DATA |
| | elements in the rgData array. |
| Return | HRESULT - NOERROR on success, or error code on |
| Value | failure. |

### IXMCDirect::InvokeMethod Method

The IXMCDirect::InvokeMethod method is used to call a specific method implemented by the component. For more information on the methods supported, see the description of the specific component.

| | |
|---|---|
| Syntax | HRESULT InvokeMethod( DWORD dwMethodIdx, |
| | LPXMC_PARAM_DATA rgData, |
| | DWORD dwCount ); |
| Pa- | DWORD dwMethodIdx - number corresponding to the |
| rameters | specific method to invoke. For more information on the |
| | method indexes available, see the set of namespaces |
| | defined for the component. |
| | LPXMC_PARAM_DATA rgData [optional] - array of |
| | XMC_PARAM_DATA types that specify each parameter for |
| | the method called. For more information on the |
| | XMC_PARAM_DATA type, see below. |
| | NOTE: if no parameters exist for the method called, a value |
| | of NULL must be passed in. |
| | DWORD dwCount [optional] - number of |
| | XMC_PARAM_DATA elements in the rgData array. |
| | NOTE: if no parameters exist for the method called, a value |
| | of 0 (zero) must be passed in for this parameter. |
| | LPXMC_PARAM_DATA rgData [optional] - namespace |
| | associated with the instance of the custom extension |
| | module added. |
| Return | HRESULT - NOERROR on success, or error code on |
| Value | failure. |

The component methods used by the client application program 32, 132 to take advantage of the data processing systems 44, 144 described above. A majority of the components used by the systems 20 and 120 support the following components; for a specific list of methods supported by each component, refer to the section describing each specific component.

### XMC_EVENT_ENABLE Method

The XMC_EVENT_ENABLE method enables/disables a previously subscribed data item in the subscription list maintained by the server. Only enabled subscriptions actually fire.

| | |
|---|---|
| Index | 2892 |
| Data In | rgData[0] - (number) DWORD, cookie (unique identifier) |
| | associated with the subscription. This value is returned to |
| | the client when calling the subscription XMCAPI above. |
| | NOTE: using a cookie value of zero (0) will enable/disable |
| | ALL items subscribed to the server. |
| | rgData[1] - (number) BOOL, TRUE to enable the |
| | subscription(s), FALSE to disable the subscription(s). Only |
| | enabled subscriptions actually fire events. |
| Data Out | None. |

### XMC_EVENT_RECEIVE_DATA Method

The XMC_EVENT_RECEIVE_DATA method is called by the server (and implemented by the client) when each subscribed event fires.

| | |
|---|---|
| Index | 8045 |
| Data In | rgData[0] - (number) DWORD, subscription cookie |
| | corresponding to the subscribed data item. |
| | rgData[1] - (number or string), data item value. |
| | rgData[2] - (OPTIONAL number) DWORD, data item time- |
| | stamp as a system time value. |
| | rgData[3] - (OPTIONAL string) LPSTR, data item ASCII text |
| | name. |
| | rgData[4] - (OPTIONAL number) DWORD, data item unique |
| | cookie. |
| | NOTE: Since the last three items are optional, only those |
| | items specified when configuring the data to receive are |
| | actually sent. If, for example, one or more data items are |
| | NOT requested, then the items are returned in slots shifted |
| | up toward rgData[1]. For example if only the data item name |
| | is requested in addition to the default data items, the data |
| | returned would look like the following: |
| | rgData[0] - (number) DWORD, subscription cookie. |
| | rgData[1] - (number or string), data item value. |
| | rgData[2] - (string) LPSTR, data item name. |
| Data Out | None. |

### XMC_EVENT_SUBSCRIBE Method

The XMC_EVENT_SUBSCRIBE method subscribes to a given data item activating the event interface when the subscription criteria are met for the data item. In the example systems 20 and 120, subscribing components use the IXMCDirect interface to receive events received from the server for which they are subscribed.

| | |
|---|---|
| Index | 2890 |
| Data | rgData[0] - (number) DWORD, flags describing the initial |
| In | state of the subscription. The following flags are supported: |
| | XMC_EVENT_FLAG_ENABLED - subscription is |
| | immediately enabled upon subscription. |
| | XMC_EVENT_FLAG_DISABLED - subscription is disabled |
| | upon making the subscription. The Enable function must be |
| | called to enable the subscription. |
| | rgData[1] - (number) DWORD, number of subscription |
| | criteria rules. |
| | rgData[2 + (2 * n)] - (number) DWORD, event condition type |
| | where the following types are supported: |
| | XMC_CNC_EVENTCONDITION_DATA_CHANGE - any |
| | data changes in the data type above will trigger the event. |
| | XMC_CNC_EVENTCONDITION_DATA_EQUAL |
| | XMC_CNC_EVENTCONDITION_DATA_LESSTHAN |
| | XMC_CNC_EVENTCONDITION_DATA_GREATERTHAN |
| | XMC_CNC_EVENTCONDITION_DATA_AND |
| | XMC_CNC_EVENTCONDITION_DATA_OR |
| | Each of the conditions above are used in a combined |
| | manner. Where the logical condition (=, <, >) are applied for |
| | each type respectively. |
| | For example, in an array that contains the following items: |
| | rgData[2] = 4 (4 condition values) |
| | rgData[3] = XMC_CNC_EVENTCONDITION_EQUAL |
| | rgData[4] = 3.0 |
| | rgData[5] = XMC_CNC_EVENTCONDITION_LESSTHAN |
| | rgData[6] = 3.0 |
| | rgData[7] = XMC_CNC_EVENTCONDITION_OR |
| | rgData[8] = 1.0 |
| | rgData[9] = |
| | XMC_CNC_EVENTCONDITION_GREATHERTHAN |
| | rgData[10] = 5.0 |
| | the array would be evaluated using the following logic: |
| | If (DATA <= 3.0 OR DATA > 5.0) then Trigger Event |
| | rgData[3 + (2 * n)] - (number) double, the value for the |
| | condition. See above. |
| Data | rgData[0] - (number) DWORD, cookie (unique identifier) |
| Out | representing the subscription. |

### XMC_EVENT_TRIGGER_ADD Method

The XMC_EVENT_TRIGGER_ADD method adds a new data item (or action) association to the subscription Actions may be implemented by associating special variables to the subscription. For example, a specially named variable such as ‘MoveLeft’ may be used to trigger an action that causes the target to move to the left.

| | |
|---|---|
| Index | 20001 |
| Data In | rgData[0] - (number) DWORD, cookie (unique identifier) |
| | associated with the subscription. This value is returned to |
| | the client when calling the subscribe XMCAPI above. |
| | rgData[1] - (string) LPCTSTR, name or tag of the variable or |
| | data item to be associated to the subscription. |
| | rgData[2] - (number) BOOL, TRUE to enable data |
| | combining. All associated data items with data combining |
| | enabled are sent to the client in a single event. |
| Data Out | rgData[0] - (number) DWORD, cookie (unique identifier) |
| | associated with the data item that is associated with the |
| | subscription. |

### XMC_EVENT_TRIGGER_BROWSE Method

The XMC_EVENT_TRIGGER_BROWSE method returns the list of data items.

| | |
|---|---|
| Index | 20003 |
| Data In | rgData[0] - (number) DWORD, cookie (unique identifier) |
| | associated with the subscription. This value is returned to |
| | the client when calling the subscription XMCAPI above. |
| | NOTE: using a cookie value of zero (0) will browse ALL |
| | event triggers for all items subscribed to the server. |
| | rgData[1] - (number) DWORD, trigger cookie (unique |
| | identifier) associated with the event trigger associated to this |
| | subscription. This value is returned to the client when calling |
| | the ‘add’ XMCAPI. |
| | NOTE: using a event cookie value of zero (0) will browse |
| | ALL event triggers associated with the subscribed item |
| Data | rgData[0] - (number) DWORD, total number of data items |
| Out | returned. |
| | rgData[1] - (number) DWORD, total number of subscriptions |
| | in the data set. Normally this is just 1, but in the case where |
| | all subscriptions are queried, this count contains the total |
| | number of subscriptions. |
| | rgData[2] - (number) DWORD, cookie (unique identifier) |
| | associated with the subscription. This value is returned to |
| | the client when calling the subscription XMCAPI above. |
| | rgData[3] - (number) DWORD, total number of data items |
| | associated to the subscription. |
| | rgData[4] - (number) DWORD, trigger cookie (unique |
| | identifier) associated with the event trigger associated to this |
| | subscription. This value is returned to the client when calling |
| | the add trigger XMCAPI. |
| | rgData[5] - (string) LPCTSTR, first variable name or data |
| | item tag in the list. |
| | rgData[6] - (number) DWORD, number of data items for the |
| | variable or data item specified in rgData[1]. This is the |
| | number of data items returned in the event to the client. |
| | rgData[7] - (string) LPCTSTR, second variable name or data |
| | item tag in the list. |
| | rgData[8] - (number) DWORD, number of data items for the |
| | variable or data item specified in rgData[3]. This is the |
| | number of data items returned in the event to the client. |
| | rgData[5 + (n/2) − 1] - (string) LPCTSTR, second variable |
| | name or data item tag in the list. |
| | rgData[5 + (n/2)] - (number) DWORD, number of data items |
| | for the variable or data item specified in rgData[5 + (n/2) − 1]. |
| | This is the number of data items returned in the event to the |
| | client. |

### XMC_EVENT_TRIGGER_ENABLE Method

The XMC_EVENT_TRIGGER_ENABLE enables/disables a previously registered event trigger data item. Only enabled event trigger data items actually fire.

| | |
|---|---|
| Index | 20000 |
| Data In | rgData[0] - (number) DWORD, cookie (unique identifier) |
| | associated with the subscription. This value is returned to |
| | the client when calling the subscription XMCAPI above. |
| | NOTE: using a cookie value of zero (0) will enable/disable |
| | ALL event triggers for all items subscribed to the server. |
| | rgData[1] - (number) DWORD, trigger cookie (unique |
| | identifier) associated with the event trigger associated to this |
| | subscription. This value is returned to the client when calling |
| | the add trigger XMCAPI. |
| | NOTE: using a event cookie value of zero (0) will |
| | enable/disable ALL event triggers associated with the |
| | subscribed item |
| | rgData[2] - (number) BOOL, TRUE to enable the event |
| | trigger data item and/or action(s), FALSE to disable. Only |
| | enabled event data items actually fire events or included in |
| | combined data events. |
| Data Out | None |

### XMC_EVENT_TRIGGER_REMOVE Method

The XMC_EVENT_TRIGGER_REMOVE removes a previously registered event trigger data item.

| | |
|---|---|
| Index | 20002 |
| Data In | rgData[0] - (number) DWORD, cookie (unique identifier) |
| | associated with the subscription. This value is returned to |
| | the client when calling the subscription XMCAPI above. |
| | NOTE: using a cookie value of zero (0) will remove ALL |
| | event triggers for all items subscribed to the server. |
| | rgData[1] - (number) DWORD, trigger cookie (unique |
| | identifier) associated with the event trigger associated to this |
| | subscription. This value is returned to the client when calling |
| | the add trigger XMCAPI. |
| | NOTE: using a event cookie value of zero (0) will remove |
| | ALL event triggers associated with the subscribed item |
| Data Out | None |

### XMC_EVENT_UNSUBSCRIBE Method

The XMC_EVENT_UNSUBSCRIBE method removes a previously subscribed data item from the subscription list maintained by the server.

| | |
|---|---|
| Index | 2891 |
| Data In | rgData[0] - (number) DWORD, cookie (unique identifier) |
| | associated with the subscription. This value is returned to |
| | the client when calling the subscription XMCAPI above. |
| | NOTE: using a cookie value of zero (0) will unsubscribe ALL |
| | items subscribed to the server. |
| Data Out | None. |

The definitions of all special types used by the methods and properties of each component forming the example motion control system 20, 120 will now be described in further detail.

### XMC_PARAM_DATA Structure

All methods exposed by each component in the example motion control system 20, 120 use the standard XMC parameters set to describe data used to set and query properties as well as invoke methods. The standard parameters are in the following format:

pObj->InvokeMethod(LPXMC_PARAM_DATA rgData, DWORD dwcount);

Each element in the rgData array corresponds to a parameter, with the first element in the array corresponding to the first parameter.

The XMC_PARAM_DATA structure can contain either a numerical or a string value and is defined as follows:

```
typedef struct tagXMC_PARAM_DATA
{
    LNG_PARAM_DATATYPE adt;
    union
    {
      double df;
      LPTSTR psz;
    };
}XMC_PARAM_DATA;
```

The ‘adt’ member of the XMC_PARAM DATA structure describes the data contained within the XMC_PARAM_DATA structure. The values are described below:

| LNG_PARAM_DATATYPE | Description |
|---|---|
| LNG_ADT_NUMBER | Use this value when passing a |
| | numerical value via the ‘adt’ member |
| | of the XMC_PARAM_DATA |
| | structure. |
| LNG_ADT_STAT_STRING | Use this value when passing a static |
| | string value via the ‘psz’ member of |
| | the XMC_PARAM_DATA |
| | structure. Static strings do not need to |
| | be freed from memory. |
| LNG_ADT_MEM_STRING | Use this value when passing a string |
| | value via the ‘psz’ member of the |
| | XMC_PARAM_DATA structure. |
| | LNG_ADT_MEM_STRING denotes |
| | that the string must be freed from |
| | memory during cleanup. |
| LNG_ADT_NOP | This value is used to ignore items |
| | within the XMC_PARAM_DATA |
| | array. When specified, this parameter is |
| | not used. |

### Boolean Types

When querying and setting boolean TRUE/FALSE values, any non-zero value is considered TRUE, whereas a zero value is considered FALSE.

One of ordinary skill in the art will recognize that the principles of the present invention may be implemented in motion control systems the details of which differ in some respects from example motion control systems 20 and 120 described above. The motion control systems 20 and 120 should be considered as illustrative examples, and the scope of the present invention should be determined based on the following claims and not the foregoing detailed description.

What is claimed is:

1. A motion control system comprising:
a data processing system that stores
a trigger variable,
a dependant action associated with the trigger variable, and
a set of predetermined trigger conditions;
a motion control device comprising
a motor, and
a drive that provides power to the motor, and
a controller that controls the drive, where the controller stores data values indicative of a state of the motion control device, and
at least one data value stored by the controller is associated with the trigger variable;
a motion driver that reads data values from and writes data values to the controller; whereby
the data processing system directs the motion driver to read from the controller, at a plurality of points in time, a trigger data value associated with the trigger variable; and
when the trigger data value associated with the trigger variable meets the predetermined trigger conditions, the data processing system directs the motion driver to take the dependant action.

2. A motion control system as recited in claim 1, in which the dependant action is for the data processing system to read data from the controller.

3. A motion control system as recited in claim 1, in which the dependant action is for the data processing system further to fire an event to an application program.

4. A motion control system as recited in claim 1, in which the dependant action is for the data processing system to write data to the controller.

5. A motion control system as recited in claim 1, in which the dependant action is for the data processing system to read data from the controller and to write data to the controller.

6. A motion control system as recited in claim 1, in which the dependant action is for the data processing system to read data from the controller and to fire an event to an application program.

7. A motion control system as recited in claim 1, in which:
the data processing system stores a dependant variable that is associated with the trigger variable;
the controller stores a data value associated with the dependant variable; whereby
the dependant action is to read from the controller the dependant data value associated with the dependant variable.

8. A motion control system as recited in claim 1, in which the data processing system defines a plurality of trigger variables.

9. A motion control system as recited in claim 7, in which the data processing system defines a plurality of dependant variables.

10. A motion control system as recited in claim 7, in which the data processing system defines:
a plurality of trigger variables; and
a plurality of dependant variables for each of the plurality of trigger variables.

11. A motion control system as recited in claim 1, further comprising an application program for defining a sequence of steps to be implemented by the motion machine, where the application program further defines the trigger variable, the dependant action associated with the trigger variable, and the set of predetermined trigger conditions.

12. A motion control system as recited in claim 1, further comprising a motion server for facilitating communication between an application program and the data processing system.

13. A motion control system as recited in claim 1, in which the data processing system is part of the motion driver.

14. A motion control system as recited in claim 12, in which the data processing system is part of the motion server.

15. A motion control system as recited in claim 1, in which the data processing system comprises:
a subscription manager for managing the storage of trigger variables, dependant actions, and predetermined trigger conditions;
an event trigger list for storing trigger variables, dependant actions, and predetermined trigger conditions; and
a drive manager for communicating with the motion driver.

16. A motion control system as recited in claim 15, in which the data processing system further comprises an event manager for firing events to an application program.

17. A motion control system as recited in claim 15, further comprising a variable manager for converting generic variables used by an application program to target specific variables used by the motion machine.

18. A motion control system as recited in claim 12, in which the motion server converts hardware independent application commands used by an application program into hardware dependent control commands used by the motion machine.

19. A method of collecting data in a motion control system comprising:
providing a motion control device comprising a motor, a drive that provides power to the motor, and a controller that controls the drive;
storing a trigger variable, a dependant action associated with the trigger variable, and a set of predetermined trigger conditions;
storing in the controller data values indicative of a state of the motion control device;
associating at least one data value with the trigger variable;
reading at a plurality of points in time, a trigger data value associated with the trigger variable; and
comparing the trigger data value associated with the trigger variable with the predetermined trigger conditions; and
taking the dependent action when the trigger data value associated with the trigger variable meets the predetermined trigger conditions.
